(19) United States
(12) Patent Application Publication
(10) Pub. No.: US 2025/0207015 A1
(43) Pub. Date: Jun. 26, 2025

(54) Self-Degrading High Viscosity Friction Reducer and Uses Thereof

(71) Applicants: Jenn-Tai Liang, College Station, TX (US); Austin Wen-Min Lim, Austin, TX (US)

(72) Inventors: Jenn-Tai Liang, College Station, TX (US); Austin Wen-Min Lim, Austin, TX (US)

(73) Assignee: The Texas A&M University System, College Station, TX (US)

(21) Appl. No.: 18/999,594

(22) Filed: Dec. 23, 2024

Related U.S. Application Data
(60) Provisional application No. 63/614,788, filed on Dec. 26, 2023.

(51) Int. Cl. C09K 8/68; C08F 220/56; E21B 43/26

(52) U.S. Cl. CPC C09K 8/685; C08F 220/56; E21B 43/26; C08F 2800/20; C08F 2810/20; C09K 2208/28

(57) ABSTRACT

Provided herein are high viscosity friction reducers that are self-degrading and a one-component system using the same high viscosity friction reducers. The high viscosity friction reducer is a crosslinked polymer, for example a crosslinked cationic polymer such as a polyacrylamide polymer. The high viscosity friction reducers are useful in a fracture well self-cleaning system without the need of a breaker.

### CROSS-REFERENCE TO RELATED APPLICATIONS

This non-provisional application claims benefit of priority under 35 U.S.C. § 119(e) of provisional application U.S. Ser. No. 63/614,788, filed Dec. 26, 2023, the entirety of which is hereby incorporated by reference.

### BACKGROUND OF THE INVENTION

### Field of the Invention

The invention relates to the fields of polymer formulations and methods for fracturing technologies. More specifically, the present invention relates to a self-degrading high viscosity friction reducer to improve fracturing without a breaker for post-fracture cleanup.

### Description of the Related Art

Degradation of the high viscosity friction reducer after hydraulic fracturing is essential to maximize well productivity. Traditional methods of degrading polymeric friction reducers involve using encapsulated breakers designed to release when crushed from the fracture closure stress. The release rate for encapsulated breakers typically ranges from 30-90% (1). Designing the optimal encapsulated breaker concentration is further complicated because increasing breaker concentration leads to premature polymer breakdown, reducing the efficacy of the polymeric friction reducer (2). Due to the complication that breakers add, researchers have begun to develop new novel HVFRs that break down without a breaker (3, 4). An HVFR with good cleanup capabilities must transform to have very different properties from its initially injected state. Initially, a high molecular weight linear polymer is needed to increase the system's viscosity and reduce drag (5). Then, once within the fracture, the polymer must break up into small enough molecules that are easily flushed out of the fracture.

Chung et al. (3) tackled this problem by designing a polymer that had weak functional groups that hydrolyzed when exposed to heat. Hydrolysis of these functional groups caused the large linear polymer molecules to collapse and reduce solution viscosity. While this method showed good viscosity degradation, the polymer molecules would block pore throats and hinder fracture cleanup when folded. A small amount of breaker was needed to break down these large polymers and improve fracture cleanup. Kot et al. (4) developed a proclaimed self-degrading HVFR using a weak labile crosslinker to link two polymer molecules. These weak labile crosslinkers showed polymer degradation of 70% at lower concentrations and about 10% at higher concentrations. The reduction in polymer degradation was attributed to new free radicals forming during the crosslinker degradation process. These free radicals would cause some degraded polymers to re-crosslink and reduce the overall polymer degradation. When a free radical scavenger was introduced into the system, the polymer degradation at high concentrations could be increased to 91%. While both these systems claim to be self-cleaning without needing a breaker, they still needed a second component to improve fracture cleanup and therefore were not actual one-component systems.

Thus, there remain unmet needs in the art for self-cleaning one-component systems for improved fracture clean-up. Particularly, the art is deficient in a self-degrading high viscosity friction reducer useful in a breaker-free one-component system for post-fracture cleanup.

### SUMMARY OF THE INVENTION

The present invention is directed to a self-degrading high viscosity friction reducer (HVFR). The high viscosity friction reducer comprises a polymer crosslinked with a crosslinker hydrolyzable at an elevated temperature.

The present invention also is directed to a method for a breaker-free fracture cleanup in a well at an elevated temperature. In the method, an amount of the self-degrading high viscosity friction reducer described herein is injected into the well effective to self-degrade, thereby breaking down a viscosified fracturing fluid and effecting fracture cleanup in the well.

The present invention is directed further to a one-component system for a fracture well clean-up. The one-component system consists of a high viscosity friction reducer (HVFR) that self-degrades over a period of time at an elevated temperature.

The present invention is directed further still to a self-cleaning method for a clean-up in a fracturing well. In this method, a viscosified fracturing fluid in the fracturing well is broken down by self-degrading therein the high viscosity friction reducer of the one-component system described herein at the elevated temperature of about 130° F. to about 195° F. over a period of time of about thirty days to about six days.

The present invention is directed further still to a high viscosity friction reducer. The high viscosity friction reducer consists of a crosslinked cationic polyacrylamide that self-degrades at an elevated temperature.

Other and further aspects, features, benefits, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIG. 1 is a schematic of the flow loop.

FIG. 2 illustrates the self-degrading high viscosity friction reducer and self-degrading mechanism.

FIG. 3 shows the viscosity of 1 wt % high viscosity friction reducer in deionized water (DI) at varying chain transfer agent (CTA) concentrations.

FIG. 4 shows the viscosity of 1 wt % high viscosity friction reducer in deionized water at varying crosslinker concentrations.

FIG. 5 shows the viscosity of 1 wt % high viscosity friction reducer in deionized water at varying reagent concentrations.

FIG. 6 shows the high viscosity friction reducer viscosity in different brines.

FIG. 7 shows the viscosity of high viscosity friction reducer in Marcellus produced water (cation) brine (MPWC) brine at various temperatures.

FIG. 8 shows the viscosity degradation of 2 wt % high viscosity friction reducer in MPWC brine at 195° F.

FIG. 9 shows the viscosity degradation of 2 wt % high viscosity friction reducer in MPWC brine at 160° F.

FIG. 10 shows the viscosity degradation of 2 wt % high viscosity friction reducer in MPWC brine at 130° F.

FIG. 11 shows the viscosity profile of uncrosslinked and self-degrading high viscosity friction reducer in MPWC brine.

FIG. 12 shows the permeability reduction during high viscosity friction reducer injection.

FIG. 13 shows the regained fracture permeability after cleanup.

FIG. 14 shows the fanning friction factor of self-degrading high viscosity friction reducer at various Reynolds numbers.

FIG. 15 shows the high viscosity friction reducer friction reduction performance at Nᵣₑ=10,000 and Nᵣₑ=20,000.

FIG. 16 shows the Fanning friction factor change over time (1 wt % high viscosity friction reducer in MPWC brine at 3.3 gpm).

### DETAILED DESCRIPTION OF THE INVENTION

As used herein, the articles “a” and “an” when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

As used herein, the term “or” in the claims refers to “and/or” unless explicitly indicated to refer to alternatives only or the alternatives are mutually exclusive, although the disclosure supports a definition that refers to only alternatives and “and/or”.

As used herein, “another” or “other” may mean at least a second or more of the same or different claim element or components thereof.

As used herein, the terms “comprise” and “comprising” are used in the inclusive, open sense, meaning that additional elements may be included.

As used herein, the terms “consist of” and “consisting of” are used in the exclusive, closed sense, meaning that additional elements may not be included.

As used herein, the term “about” refers to a numeric value, including, for example, whole numbers, fractions, and percentages, whether or not explicitly indicated. The term “about” generally refers to a range of numerical values (e.g., ±5-10% of the recited value) that one of ordinary skill in the art would consider equivalent to the recited value (e.g., having the same function or result). In some instances, the term “about” may include numerical values that are rounded to the nearest significant figure. In a non-limiting example an elevated temperature for polymer hydrolysis of about 160° F. encompasses temperatures of 144° F. to 156° F.

As used herein, the term “polymer” refers to non-functionalized and functionalized polymers, including homopolymers and copolymers. The copolymer is not limited to two types of monomeric units, but may be any combination of polymers, for example, terpolymers, tetrapolymers, etc.

As used herein, the term “elevated temperature” refers to a temperature from about 130° F. to about 205° F. at which the crosslinker in the crosslinked polymer hydrolyzes where the time period over which hydrolysis occurs is dependent on the temperature.

In one embodiment of the present invention, there is provided a self-degrading high viscosity friction reducer, comprising a polymer crosslinked with a crosslinker hydrolyzable at an elevated temperature.

In this embodiment, the polymer may be a non-functionalized polymer or a functionalized polymer comprising at least one monomeric unit. Also in this embodiment hydrolysis of the crosslinker in the polymer at the elevated temperature may enable self-degradation of the high viscosity friction reducer in the absence of a breaker. Particularly, the polymer may be crosslinked with polyethylene glycol diacrylate (PEGDA), polyethylene glycol monomethacrylate (PEGMA) or 3,0-Divinyl-2,4,8,10-tetraoxaspiro[5,5]undecane (DVA). In addition, in this embodiment the HVFR viscosifies the fracture fluid in a brine. Furthermore, the elevated temperature may be about 130° F. to about 205° F.

In another embodiment of the present invention, there is provided a method for a breaker-free fracture cleanup in a well at an elevated temperature, comprising injecting an amount of the self-degrading high viscosity friction reducer, as described supra, into the well effective to self-degrade, thereby breaking down a viscosified fracturing fluid and effecting fracture cleanup in the well. In this embodiment the high viscosity friction reducer may self-degrade over about six days when the elevated temperature is about 195° F. or over about thirteen days when the elevated temperature is about 160° F. or over about thirty days when the elevated temperature is about 130° F.

In yet another embodiment of the present invention, there is provided a one-component system for a fracture well clean-up, consisting of a high viscosity friction reducer that self-degrades over a period of time at an elevated temperature.

In this embodiment, the high viscosity friction reducer may comprise a polymer crosslinked with a crosslinker that hydrolyzes at the elevated temperature. Particularly, the polymer may be a crosslinked polyethylene glycol diacrylate (PEGDA), polyethylene glycol monomethacrylate (PEGMA) or 3,0-Divinyl-2,4,8,10-tetraoxaspiro[5,5]undecane (DVA).

In this embodiment, the crosslinker in the polymer may degrade at the elevated temperature of about 130° F. to about 195° F. over a period of time of about thirty days to about six days. Particularly, the crosslinker in the polymer may degrade at 130° F. over about 30 days, at 165° F. over about 13 days or at 195° F. over about 6 days. In addition, the HVFR may be viscosified in a brine. Furthermore, self-degradation of the HVFR may enable a system that self-cleans absent a breaker.

In yet another embodiment of the present invention, there is provided a self-cleaning method for a clean-up in a fracturing well, comprising breaking down a viscosified fracturing fluid in the fracturing well by self-degrading therein the high viscosity friction reducer of the one-component system, as described supra, at the elevated temperature of about 130° F. to about 195° F. over a period of time of about thirty days to about six days.

In this embodiment, the polymer may be a crosslinked polyacrylamide. Also, in this embodiment self-cleaning may occur absent a breaker.

In yet another embodiment of the present invention, there is provided a high viscosity friction reducer, consisting of a crosslinked cationic polyacrylamide polymer that self-degrades at an elevated temperature.

In this embodiment, the cationic polyacrylamide polymer may be crosslinked with polyethylene glycol diacrylate (PEGDA). Also, in this embodiment the elevated temperature may be about 130° F. to about 205° F.

Provided herein is a self-degrading high viscosity friction reducer or a one-component system comprising the same. The self-degrading high viscosity friction reducer is a weakly crosslinked cationic polyacrylamide polymer. The crosslinker in the polymer is designed to hydrolyze at elevated temperatures, allowing the polymer to self-degrade without a breaker during a fracture cleanup. Examples of the crosslinker in the polymer are, but not limited to, polyethylene glycol diacrylate (PEGDA), polyethylene glycol monomethacrylate (PEGMA) or 3,0-Divinyl-2,4,8,10-tetraoxaspiro[5,5]undecane (DVA).

The polymer backbone can be made of an acrylic, vinyl, allyl, maleic, or acrylamide based nonionic monomer. Examples of nonionic monomers are, but not limited to, acrylamide, methacrylamide, N-vinyl pyrrolidone, and N-vinylformamide. The charge of the polymer may be changed using a charged functional group to be cationic or anionic. Examples of cationic functional groups are, but not limited to, trimethylammonium chloride (TMAC), dimethylamoniethylacrylate (ADAME) quaternized, dimethylaminoethylmethacrylate (MADAME) quaternized, dinriethyldiallylammonium chloride (DADMAC), acylamido propyltrimethyl ammonium chloride (APTAC), methacryulamido propyltrimethyl ammonium chloride (MAPTAC). Examples of anionic functional groups are, but not limited to, 2-acrylamido-2-methylpropane sulfonic acid (AMPS) and N, N-dimethylacrylamide (DMAA).

Self-degradation of the high viscosity friction reducer is enabled by the elevated temperatures at which hydrolysis occurs and encompasses a range of about 130° F. to about 205° F., more preferably a range of about 130° F. to about 195° F. A specific elevated temperature is about 160° F. Self-degradation may occur over a period of time of about 6 days to 30 days that is dependent on the elevated temperature, for example, 6 days, 13 days or 30 days. In a non-limiting example, hydrolysis occurs at about 160° F. over a period of about 6 days.

Also provided are methods for cleaning a fracture well by utilizing the self-degrading high viscosity friction reducer or a one-component system described herein. Fracture well cleaning is effected at the elevated temperature over a temperature dependent period of time without a breaker present in the well.

The following examples are given for the purpose of illustrating various embodiments of the invention and are not meant to limit the present invention in any fashion.

### Example 1

### Methods and Materials

### High Viscosity Friction Reducer Synthesis

### High Viscosity Friction Reducer Synthesis: Materials and Experimental Equipment

Several attempts were made to establish an ideal recipe for high viscosity friction reducer synthesis. Different ratios of reagents were tried until a cationic high viscosity friction reducer polymer with the desired characteristics for this study was created. The reagents used for high viscosity friction reducer synthesis, and their function are given in Table 1 below.

TABLE 1
Reagents used for cationic HVFR synthesis

| Name | Function |
|---|---|
| Acrylamide | Scale Inhibitor |
| Trimethyl Ammonium | Brine Compatibility |
| Chloride (TMAC) | Agent |
| Polyethylene Glycol | Self-degrading |
| Diacrylate PEGDA) | Crosslinker |
| Thioglycolic acid | Chain Transfer |
| | Agent |
| 2,2′-Azobis(2- | Initiator |
| methylpropionamidine) | |
| dihydrochloride (VAZO 56) | |

### High Viscosity Friction Reducer Synthesis: Experimental Procedure

The following procedure documents the synthesis of a novel high viscosity friction reducer. The same procedure can be used to create non-crosslinked linear cationic polyacrylamide with the omission of the crosslinking agent.
1. Prepare an appropriately sized round bottom flask, stir bar, rubber stopper, hose clamp, and nitrogen gas tank.
2. Calculate the proper mass of all reagents.
3. Add ˜75 wt % of the desired deionized water (DI) to the round bottom flask and record the mass.
4. Add acrylamide, trimethyl ammonium chloride, polyethylene glycol diacrylate, and thioglycolic acid to the round bottom flask, and record all masses.
5. Mix the solution until homogenous.
6. Add 2,2′-Azobis(2-methylpropionamidine) dihydrochloride (VAZO 56) to the round bottom flask and record the mass.
7. Prepare 10 wt % NaOH in DI, and add NaOH solution to adjust pH while stirring until a pH of ˜3.77 is achieved. Record the mass of NaOH solution added.
   a. pH 3.77 is desired because that is when the polymerization rate for all monomers is equal (Haque 2010).
8. Add the remainder of the water to reach the desired total concentration of polymer solution, and record mass.
9. Place the rubber stopper over the round bottom flask and fix the hose clamp around the stopper to ensure an air-tight seal.
10. Attach a steel needle to a nitrogen gas supply hose and insert the steel needle until submerged in the solution. Place another needle in the rubber stopper as a vent/outlet needle.
11. Stir the solution for 15 minutes while purging it with nitrogen.
   a. Before turning on the nitrogen, double-check that the flask has a proper vent. Failure to do so could cause accidental over-pressurization of the round bottom flask and injury.
12. After the nitrogen purge, turn off the nitrogen supply and remove both needles from the rubber stopper.
13. Place the HVFR solution in a water bath, heated to ˜140° F., and stir at ˜ 150 revolutions per minute (rpm) for ˜2 hours.
14. Using the recorded masses in steps 4, 6, 7, and 8, calculate the activity of the synthesized HVFR as a mass fraction. The equation for calculating HVFR activity is given in Eq. 1 below.

$$HVFR Activity ( wt \% ) = \frac{\sum {m}_{reagents}}{\sum {m}_{reagents} + {m}_{ph balance} + {m}_{solvent}} \qquad ( Eq . 1 )$$

### High Viscosity Friction Reducer Rheological Measurements

This section describes the methods and equipment used to measure the HVFR viscosity as a function of shear rate. Since procedures vary depending on the type of equipment used, only the basic steps in viscosity sample measurements are described in this section.

### High Viscosity Friction Reducer Rheological Measurements: Experimental Equipment and Procedure

A Grace 5600 HPHT rheometer was used. The rheometer is equipped with a B5 bob and a 55 mL sample cup—the sample cup screws on to create a closed system that allows for high-pressure and high-temperature rheological measurements. The cup is heated with a carbon heating block that is lifted into position during measurements.

Samples were first loaded into the sample cup. The loaded sample cup was then mounted onto the rheometer. The samples were pre-heated to the desired testing temperature before beginning the experiment. Once samples reached the testing temperature, the sample's viscosity was measured at varying shear rates.

### High Viscosity Friction Reducer Degradation Experiments

This section describes the materials, equipment, and methods used to measure high viscosity friction reducer degradation over time. As the high viscosity friction reducer polymer degrades, the high viscosity friction reducer solution viscosity decreases. Therefore, the change in high viscosity friction reducer viscosity is a good indicator of high viscosity friction reducer polymer degradation.

### High Viscosity Friction Reducer Degradation Experiments

### Brine:

Four solvents were used to dilute the high viscosity friction reducer stock to capture any difference brine composition has on high viscosity friction reducer degradation. The solvents used in this study were DI, 10 wt % NaCl in DI, 1 wt % CaCl₂) in DI, and synthetic Marcellus produced water. Scale-forming anionic components, such as carbonates and sulfates, were removed from the synthetic Marcellus produced water. This mainly left the cationic components, which would have the most considerable impact on high viscosity friction reducer performance. The brine composition of MPWC is given in Table 2 below.

TABLE 2
Marcellus Produced Water (Cation) Brine Composition

| Salt | Wt. (g/Kg) |
|---|---|
| MgCl₂*6H₂O | 4.3969 |
| SrCl₂*6H₂O | 2.1110 |
| BaCl₂*6H₂O | 2.4151 |
| CaCl₂*6H₂O | 21.4236 |
| KCl | 0.7245 |
| NaCl | 51.3000 |
| Total Salinity | 73.52 |
| Total Hardness | 92.60 |
| (mmol/Kg water) | |

### Ampoule:

Samples were sealed in 20 mL pre-scored borosilicate ampoules with an acetylene-oxygen torch. This ensured that the incubation of these samples occurred under anaerobic conditions with no evaporation.

### Gravity Convection Oven:

A Thermo Scientific Precision Model 658 Oven was used to incubate samples. The oven was retrofitted with two thermal controllers connected to a thermocouple placed inside the oven. The thermal controllers maintained the oven temperature without forced air convection.

### High Viscosity Friction Reducer Degradation Experiments: Experimental Procedure

In aerobic conditions, all polymers degrade at elevated temperatures. This is usually not an issue since the reservoir is anaerobic. Therefore, it is crucial to ensure long-term polymer studies are performed in anaerobic conditions to simulate reservoir conditions. To ensure that high viscosity friction reducer samples were incubated in an oxygen-free environment, all samples were purged with nitrogen and placed in ampoules with a nitrogen blanket. Therefore, the procedures below include steps to prepare the samples for sample incubation under anaerobic conditions and can be omitted if necessary.
1. Prepare 0.5, 1, 2, and 3 wt % high viscosity friction reducer with desired brine in a beaker with a magnetic stir bar.
2. Place the prepared sample on a stir plate and mix at 1200 (rpm) until the high viscosity friction reducer solution is homogeneous.
   a. Depending on the concentration of the high viscosity friction reducer solution, this can be anywhere between 10 minutes to 3 hours.
3. Reduce the stir bar speed to 200 rpm, and place a clean nylon tube connected to a nitrogen source at the bottom of the high viscosity friction reducer solution.
4. Bubble the high viscosity friction reducer solution for 15 minutes while constantly mixing to remove any dissolved oxygen in solution.
5. Distribute the oxygen-free high viscosity friction reducer solution into properly labeled glass ampoules.
   a. Avoid overfilling the glass ampoules, as the liquid will expand when heated.
6. Fill the empty headspace of the ampoules with nitrogen gas to remove any oxygen from the ampoule.
7. Seal the top of the ampoules with an acetylene-oxygen torch to prevent any gas escape or evaporation.
8. Place the ampoules in the oven to incubate.
9. Measure the viscosity of the incubated samples periodically to evaluate the degradation of the high viscosity friction reducer.
   a. Measured samples should not be reused and should be discarded after measurements.

### Fracture Conductivity Experiments

This section describes the materials, equipment, and methods for lab-scale high viscosity friction reducer fracture fluid cleanup experiments. Since propped fractures consist of high-permeability sand as proppants, sandpack experiments were used to simulate a propped hydraulic fracture. The experimental procedure for preparing and characterizing the sandpack is similar to that developed by Guan et al. (6).

### Brine:

Fracture conductivity experiments were performed in MPWC brine to closer replicate field application. The brine composition for MPWC is given in Table 2.

### Sand:

100-mesh Ottawa sand was used in these experiments. Ottawa sand is a quartz sand commonly used in unconventional hydraulic fracturing applications. The sand was provided as an industry sample for academic research. Due to this sand's consistent size, the sandpack properties were predictable and consistent and, if prepared correctly, would yield a porosity of ˜35% and a permeability of ˜6 Darcy.

### Sandpack Holder:

A 12-inch long, 1-inch in diameter stainless-steel tube was used as a sandpack holder. Swagelok fittings attached to three-way valves on either end of the stainless-steel tube created a sealed sandpack holder. Stainless steel 200-mesh screens were used on both ends to prevent sand migration out of the holder.

### Mechanical Vibrating Table:

A mechanical vibrating table was used during the sand-packing process. This table had a clamp to hold the sandpack while sand was loaded into the holder, ensuring uniform sand packing.

### UV-Vis Spectrometer:

An Agilent Technologies Cary 60 UV-Vis Spectrophotometer was used during the sandpack characterization phase. The spectrophotometer measures light transmission through a sample and reports the absorbance of light at varying wavelengths.

### Oven:

The sandpack was incubated in a forced air laboratory oven, Cascade TEK TFO-28. The sandpack holder was connected to a pump and a pressure transducer outside the oven.

### Pump:

A Chandler Engineering QX6000 Quizix Precision Pump was used to pump fluid to the sandpack. The pump is a dual-cylinder piston pump that can deliver fluids either at a constant rate or pressure.

### Pressure Monitoring and Data Acquisition:

An Emerson Rosemount 3051C Differential Pressure Transducer with an attached digital gauge was used to measure the pressure drop across the sandpack. The maximum differential pressure measurement of the transducer was 10 psi.

The transducer accepts signals in 4-20 mA HAART and can be sent to a data acquisition system that converts the signal into a pressure reading. A NI-9203 National Instruments Data Acquisition module collected the signal from the pressure transducer and delivered it to a computer equipped with LabVIEW. The pressure signal was recorded on LabVIEW and then stored for analysis.

### Fraction Collector:

A Teledyne ISCO Retriever 500 fraction collector collected fractional effluent samples during the sandpack characterization phase. Volumetric test tubes can be loaded into holders that sit on a sliding boat. Fractional collection times are set on the input panel, and the boats rotate in set time increments for sample collection.

### Backpressure Regulator:

Due to the experiments' high temperature, a backpressure regulator was used to increase the system's pressure and prevent evaporation of the fluid in the sandpack. A Swagelok KBP Diaphragm backpressure regulator was used on the outlet end of the sandpack to increase the pressure of the overall system.

### Fracture Conductivity Experiments: Experimental Procedure

### Sandpack Preparation:

1. Using a 200-mesh steel screen, cut two discs that fit against the Swagelok fittings of the steel pipe. Place the two discs into the fitting that will become the column bottom. Mark the fitting so that the flow direction in the column is clear.
   a. The steel screens should help to prevent sand migration into the tubing, which would cause undesired sand production and tubing blockages.
2. Assemble the Swagelok endcaps on the steel pipe. Attach the endcaps to three-way valves with ⅛-inch nylon tubing.
3. Perform an initial leak test by attaching a vacuum gauge to one valve and pulling a vacuum through the other valve. Observe the vacuum gauge and ensure no air enters the evacuated sandpack holder.
   a. If a leak is detected, apply positive gas pressure to the holder. Apply soapy water to the fittings to detect the location of the leak. Adjust the fittings accordingly to seal the leaks.
      i. When using positive gas pressure, Take appropriate safety precautions to mitigate any potential harm from equipment failure.
4. Once the pipe passes the leak test, weigh and record the empty column mass.
5. Unscrew the top of the column and attach the column to a mechanical vibrating table.
   a. Ensure that the bottom of the column has the two screens placed in step 1
6. Turn on the vibrating table and slowly add the 100-mesh Ottawa Sand until it is about 0.5 inches from the top of the column.
   a. The vibrating table ensures uniform packing of the sand by constantly agitating the surface. Sand should be added slowly so that proper packing is guaranteed.
   b. Adding ˜10 g of sand to the column is advised before turning on the vibrating table. This ensures enough weight is applied to the screen before the vibrations begin. If this is not done, the initial sand can migrate between the screens and into the tubing causing unwanted blockages.
7. Turn off the vibrating table and inspect the bottom of the column for any sand in the nylon tubing.
   a. If sand is present in the nylon tubing, try to clear the sand. If no more sand migrates into the nylon tubing, it is done. If sand continues migrating into the nylon tubing, the screens must be re-set and the column re-packed.
8. Place the top fittings back on the column. Attach a vacuum gauge to the top of the column and perform another leak test.
   a. If a leak is detected, adjust the top endcap accordingly until the sandpack holder is no longer leaking.
9. Remove the column from the vacuum pump and remove the nylon tubing from the top endcap.
10. Turn on the vibrating table and add more sand through the top endcap to fill the remaining void space.
11. Roll a small piece of steel screen into a ball, place it through the opening of the top endcap, and reattach the nylon tubing and three-way valve.
12. Perform one final leak test to ensure the system is completely sealed.
13. Weigh and record the mass of the sand-filled column.
   a. The difference in weight before and after adding the sand will give us the total weight of the sand in the sandpack.
14. Prepare synthetic MPWC brine; the exact components are in Table 2.
15. Pull a vacuum from the top of the column. Using the vacuum's negative pressure, pull the brine from the bottom of the sandpack.
   a. Loading brine bottom up helps to remove any trapped gasses in the sandpack by vacuuming it out the top and ensures complete saturation of the sandpack.
16. Once the column is saturated, weigh and record the saturated sandpack mass.
17. The difference in weight before and after saturating the column will give us the total pore volume of the sandpack. Assume the density of the brine is 1 g/mL.

### Sandpack Characterization: Permeability Test:

1. Prepare MPWC Brine.
2. Using the dimensions of the steel pipe and Swagelok fittings, calculate the effective diameter of the column using Eq. 2 below, where Iₙ is the segment's length, hot is the column's total length, and Dₙ is the diameter of the segment.

$${D}_{eff} = \sum ( \frac{{l}_{n}}{{l}_{tot}} ) ( {D}_{n} ) \qquad ( Eq . 2 )$$

3. Connect the effluent line to the top of the column and the injection line to the bottom.
4. Pump MPWC brine slowly (˜0.5 mL/min) from the bottom.
5. Once the brine is seen in the effluent line, remove the top nylon tubing and use tweezers to remove the balled steel screen placed earlier.
   a. This screen is removed to ensure no HVFR is filtered out of the solution during the injection phase.
   b. A slow rate must be used to prevent sand production, which can ruin the mass balance of the system.
6. Re-secure the top nylon tubing and keep running brine through until there is no air in the tubing.
   a. If pumping is stopped before removing all air in the tubing, gas could be injected into the sandpack, turning the system from single-phase to two-phase.
7. Stop pumping and remove both injection and effluent lines.
8. Change the lines so that the flow direction is reversed again.
   a. When injecting, positive pressure on the system from the top will prevent unwanted sand production.
9. Connect a differential pressure transducer to the injection and effluent lines.
   a. This will allow for a pressure drop to be measured across the sandpack.
10. Use DI water to purge the transducers and remove any air bubbles trapped in the lines.
11. Inject MPWC brine through the column while measuring the pressure drop. Make sure the flow rate is changed at least three times, and make a note of the pressure drop at each flow rate change.
12. Calculate the average sandpack permeability and record it.
   a. Using the flow rate and measured pressure drop, the permeability can be calculated using the Darcy-Buckingham equation given in Eq. 3, where k is permeability, q is flow rate, μ is viscosity, L is length, A is the cross-sectional area, and ΔP is the pressure drop across the column.
   b. The average brine permeability, kᵢₙᵢₜᵢₐₗ, will be used as the original sandpack permeability in future fracture cleanup calculations.

$$k = \frac{q * μ * L}{A * Δ P} \qquad ( Eq . 3 )$$

13. On a scatter plot, plot the calculated permeability vs. measured pressure drop.
   a. Due to Darcy's Law, the plot should be linear. If it is non-linear, it most likely means the system has gas. If this is the case, the column will need to be re-packed.

### Sandpack Characterization: Tracer Test:

1. Prepare MPWC Brine.
2. Prepare 1 wt % KNO₃ as a conservative tracer in MPWC brine.
3. Place graduated test tubes in a fraction collector.
   a. Typically, a fraction size of ˜0.1 pore volumes (PV) is used. Place enough test tubes to collect ˜3 PV of samples.
4. Drain any remaining effluent into a waste container.
   a. This ensures that mass balance is maintained during pore volume calculations.
5. Purge the injection line with 1 wt % KNO₃ in MPWC brine.
6. Begin pumping 1 wt % KNO₃ in MPWC at 1 mL/min.
7. Start the fraction collector as soon as the effluent reaches the end of the tubing.
8. After ˜1.5 PV, stop the pump and pause the fraction collector. Drain the effluent line into the current collection tube. Rotate to a new collection tube.
9. Change the injection fluid to MPWC brine with no KNO₃ and purge the injection line.
10. Repeat steps 4-7 with MPWC brine.
11. At the last tube, turn off the pump and fraction collector. Drain the remaining effluent line into the last collection tube.
12. Transfer all samples to cuvettes for UV spectrophotometry analysis.
   a. NO₃⁻ absorbs light at a wavelength of 300 nm. We set the UV-Vis to measure the absorbance at 300 nm to get quantitative measurements of KNO₃ in the sample.
13. Prepare and run five concentrations of KNO₃ in MPWC brine ranging from 0-1 wt % KNO₃.
   a. These samples will create a calibration curve of absorbance to concentration for analysis.
14. Run the samples and use the calibration curve to calculate the concentration of KNO₃ in each sample.
15. Plot the normalized concentration (C/Cₘₐₓ) versus pore volumes injected.
16. The liquid pore volume of the sandpack is when C/Cₘₐₓ=0.5.
   a. When determining whether the sandpack is adequate, two things must be considered:
      i. The curve must be symmetrical without very little residual tail.
15. This is especially important in this sandpack because the sandpack should be almost entirely uniform.
   ii. The normalized concentration of 0.50 should correspond with one injected PV. This would mean the tracer PV measurement agrees with the gravimetric PV measurement.
   b. If these criteria are not met, the sandpack should be re-packed.

### Fracture Cleanup Tests:

1. Heat the sandpack to 195° F. Allow ˜24 hours for the entire sandpack to come to thermal equilibrium.
   a. Place a backpressure regulator (BPR) set to at least 20 psi back pressure on the effluent line and open the valve to the core.
      i. This will allow the fluids in the column to expand safely and prevent the system from over-pressurizing.
      ii. The BPR will raise the boiling point of the system so that the brine does not boil during the experiment.
2. Prepare ˜3.5 PV of 1 wt % of high viscosity friction reducer stock solution in MPWC brine in a beaker with a magnetic stir bar.
3. Mix the high viscosity friction reducer stock solution at 1200 rpm until homogeneous.
4. Reduce the stir bar speed to 200 rpm, place a clean nylon tube connected to a nitrogen source, and secure it to the bottom of the beaker.
5. Bubble the high viscosity friction reducer solution with nitrogen for 15 minutes under constant mixing to remove dissolved oxygen in solution.
6. While the high viscosity friction reducer stock solution is bubbled with nitrogen, purge the pressure transducer with DI water.
7. Load the oxygen-free high viscosity friction reducer solution into an air-tight accumulator under a vacuum to keep the solution free of oxygen.
8. Flush the injection line with the high viscosity friction reducer solution and ensure complete loading of the high viscosity friction reducer solution in the injection lines.
9. Drain any fluid in the effluent line into a waste container. Then place the effluent line in a graduated cylinder. Record the pump volume on the injection pump.
   a. The injection volume will be used to calculate the volume of high viscosity friction reducer injected. The effluent in the graduated cylinder will be used to confirm the pump volume calculations.
10. Inject the high viscosity friction reducer solution at 15 ft/D for a total of 3 PV.
11. Record the pressure drop during high viscosity friction reducer solution saturation to observe any potential permeability reduction during pumping due to sandpack plugging.
12. After the injection, stop the pump and drain the effluent line into the graduated cylinder. Record the final pump volume and verify it against the collected effluent volume.
13. Shut in the column at 195° F. for 7 days.
14. Prepare an accumulator filled with MPWC brine.
15. Connect the accumulator filled with MPWC brine to the sandpack. The direction of flow should be reversed from the high viscosity friction reducer saturation flow direction.
   a. Reversing the flow direction allows us to observe and remove any polymer screenout effects that may have occurred on the sandpack face.
16. Record the initial pump volume.
17. Begin injecting MPWC brine at 15 ft/D for a total of 3 PV.
18. Record the pressure drop during the MPWC brine flood to observe any potential permeability reduction during the sandpack cleanup.
19. Calculate and record the end-point permeability using Eq. 3. This end-point permeability, k_{cleanup}, will be used to calculate the retained fracture permeability.
20. Using Eq. 4, calculate and record the retained fracture permeability.

$$Retained Fracture Permeability ( \% ) = \frac{{k}_{cleanup}}{{k}_{initial}} \times 100 \qquad ( Eq . 4 )$$

### Flow Loop Experiments

This section describes the materials and methods used for lab-scale measurements of high viscosity friction reducer friction reduction capabilities using a flow loop. Flow loop studies are a quick and robust method to screen friction reducers for their drag-reduction capabilities.

### Flow Loop Experiments: Materials and Experimental Equipment

### Brine:

Flow loop experiments were performed in MPWC brine to closer replicate field applications. The brine composition for MPWC is given in Table 2.

### Flow Loop:

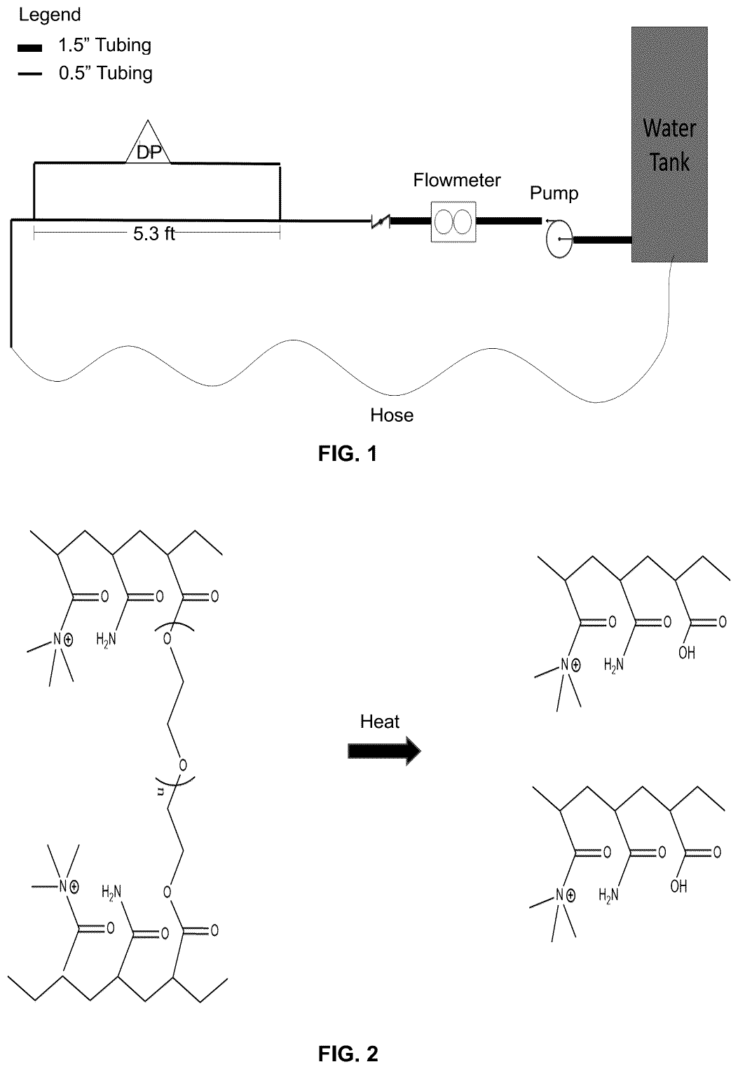

A 10-foot long flow loop was used in these studies (FIG. 1). The pipe used was a 0.5-inch diameter schedule-80 PVC pipe. A differential pressure transducer connected to the flow loop measured the pressure drop across a straight 5-foot section of the loop. Fluid was pumped from the stock tank into the flow loop using an Iwaki Magnetic drive centrifugal pump capable of delivering 8 ft of head pressure at 5 gallons per minute (gpm). An in-line flow meter was placed directly after the pump to measure the real-time flow rate entering the flow loop. The flow loop had 2.5 ft of unmeasured space on either end to ensure flow stabilization before reaching the measured section. The outlet was connected to a 1-inch diameter flexible hose that was connected back to a 40-gallon stock tank to create a closed-loop system.

### Pressure Monitoring:

An Emerson Rosemount 3051C Differential Pressure Transducer similar to the one described in the previous section was used to measure the pressure drop across the flow loop. The maximum differential pressure measurement of the transducer was 10 psi.

### Flow Loop Experiments: Experimental Procedure

The following procedure documents the measurement of the drag reduction capabilities of the newly developed self-degrading high viscosity friction reducer. All flow loop measurements were performed at ambient temperature and pressure.
1. Fill the stock tank with MPWC brine.
   a. Enough brine must be in the stock tank to maintain a large enough pressure head to prevent pump cavitation.
2. Pre-mix the high viscosity friction reducer with a small amount of MPWC brine.
   a. Since the synthesized high viscosity friction reducer is typically a weak gel, the high viscosity friction reducer should be homogenized in solution before being added into the stock tank.
   b. A dilution calculation should be done to ensure that the volume of pre-mixed high viscosity friction reducer+current brine volume in the stock tank is the target concentration.
3. Turn on the pump to the flow loop and circulate the fluid for several minutes.
4. Measure and record the differential pressure across the flow loop with the MPWC brine at five different flow rates before adding the high viscosity friction reducer.
   a. This will give the baseline pipe friction along the flow loop and will be used when evaluating the high viscosity friction reducer drag reduction performance.
5. While the pump is on the slowest possible flow rate, add the pre-mixed high viscosity friction reducer solution to the stock tank. Circulate the fluid for 30 minutes to adequately mix the high viscosity friction reducer solution within the flow loop.
6. Measure and record the differential pressure of the high viscosity friction reducer solution at five different flow rates.
   a. This will give the high viscosity friction reducer solution pipe friction along the flow loop and will be used in evaluating the high viscosity friction reducer drag reduction performance.
7. Take a sample of the high viscosity friction reducer solution from the stock tank and measure the viscosity using a rheometer.
   a. This will give us the solution viscosity that will be used to calculate the Reynolds number of the solution at the five different flow rates that the pressure drop was measured.

### Example 2

### Self-Degrading High Viscosity Friction Reducer (HVFR) Design

This study's proposed high viscosity friction reducer is a weakly crosslinked cationic polyacrylamide. The hypothesis is that the crosslinker can link multiple smaller polyacrylamide chains to create a larger molecular weight polymer molecule that can provide the desired viscosity and friction reduction capabilities. Then, after being pumped in the fracture, the reservoir heat will hydrolyze the weak bonds connecting the polyacrylamide molecules (FIG. 2), reducing the viscosity to water-like and improving fracture fluid cleanup. This hydrolysis occurs without needing an additional breaker and is a true one-component system.

A cationic polyacrylamide was chosen for this study due to its increased benefits. Firstly, due to the bulky functional group on cationic polymers, they are much more resilient in harsh brine conditions than their anionic counterparts (7, 8). This makes cationic polyacrylamides ideal when fresh water is limited and produced water is the only available water source. In addition, the cationic charge of the polymer allows it to act as a clay stabilizer. Using a cationic polyacrylamide ensures minimal formation damage due to fines migration without extra clay stabilizing additives (7, 9). Finally, the positive charge allows for better compatibility with other positively charged additives in the fracture fluid, such as biocides and surfactants. These benefits outweigh cationic polyacrylamides' additional chemical costs over anionic polyacrylamides.

Changing the reagent concentrations and ratios allow the tuning of this novel self-degrading high viscosity friction reducer to have a high initial molecular weight and low final breakdown molecular weight. The first reagent that directly impacts polymer molecular weight is the CTA. CTAs control the molecular weight of the polymer by terminating the polymerization process through the consumption of free radicals (10). The more CTA added to the reaction, the lower the polymer molecular weight and the narrower the molecular weight distribution. The crosslinker concentration can also impact the polymer's molecular weight. Increasing the crosslinker concentration would crosslink multiple polymers with lower molecular weight, creating a higher molecular weight polymer. The crosslinker and the CTA concentrations can be optimized to create a polymer with a high enough initial molecular weight and low degraded final molecular weight. Therefore, identifying the ideal CTA and crosslinker concentrations would be essential in optimizing the high viscosity friction reducer polymer. Finally, changing the total monomer concentration during synthesis can control the polymer's molecular weight and product consistency. Increasing the monomer concentration will increase the reaction rate, increasing the polymer's molecular weight. In addition, the increased reaction rate will also increase the polymer yield, creating a more stable and consistent polymer (11). By adjusting the ratio of these reagents, both the initial and degraded molecular weight of the high viscosity friction reducer polymer can be optimized to provide a high viscosity friction reducer with good drag reduction capabilities that also breaks down well without the need for an additional breaker.

### Measuring Friction Reduction Capabilities of Non-Newtonian HVFRs

The friction reduction capabilities of friction reducers are commonly measured as a percent reduction in frictional pressure at a constant flow rate. This method has been sufficient because current friction reducer concentrations are so low that they do not change fluid rheology. However, the concentration of polymer required for high viscosity friction reducer applications is large enough to change the fluid from a Newtonian to a non-Newtonian fluid. In addition, since the Reynolds number is inversely proportional to fluid viscosity, an high viscosity friction reducer fluid will have a significantly lower Reynolds number than a slickwater fluid. Therefore, comparing Fanning friction factors and Reynolds numbers is more meaningful than pressures and flow rates in these situations.

Eq. 5, Eq. 6, and Eq. 7 are used to calculate the Fanning friction factor using the measured pressure drop along a section of pipe, where f is the Fanning friction factor. v is the fluid velocity, L is the pipe length, D is the pipe diameter, and τ is the wall shear stress and is valid for all flow regimes (12, 13):

$$Δ {P}_{friction} = \frac{2 f ρ {v}^{2} L}{D} , \qquad ( Eq . 5 )$$

$$f = \frac{τ}{ρ {v}^{2}} \qquad ( Eq . 6 )$$

$$τ = \frac{Δ P * D}{2 L} . \qquad ( Eq . 7 )$$

In order to correctly calculate the Reynolds number, the apparent viscosity along the pipe wall must be estimated. The shear rate at the pipe wall can be estimated using the Carreau model equation, shown in Eq. 8 below. Where μ_{∞} is the high-shear viscosity, μ₀ is the low-shear viscosity, y is the shear rate, A is the relaxation time, and n is the power-law index (14).

$$τ = {μ}_{∞} * \dot{γ} + ( {μ}_{0} - {μ}_{∞} ) * \dot{γ} * {( 1 + {( λ \dot{γ} )}^{2} )}^{\frac{n - 1}{2}} \qquad ( Eq . 8 )$$

Using Eq. 5, Eq. 6, and Eq. 7 above, the Fanning friction factor and the Reynolds number of a fluid at a particular pump rate can be calculated. The friction reduction of the high viscosity friction reducer at a constant Reynolds number can then be calculated using Eq. 9 below.

$$FR \% = \frac{{f}_{water} - {f}_{FR}}{{f}_{water}} * 100 {\vert}_{Nre = constant} . \qquad ( Eq . 9 )$$

### HVER Optimization

The optimization process was performed in three stages to develop a consistent polymer that sufficiently increases fluid viscosity. The first stage was optimizing the chain transfer agent to develop a polymer with good viscosity while still being easily dispersed in water. The second stage was optimizing the crosslinker concentration to form the weak bonds that allowed for a high initial viscosity and good polymer breakdown. Finally, the total monomer concentration was changed to tune the high viscosity friction reducer polymer molecular weight for a consistent synthesized product. The original acrylamide, TMAC, and initiator concentrations were derived from a separate work (6) in developing a degradable nanosized scale inhibitor. This ratio of reagents provided excellent brine compatibility and polymerization (6).

### Chain Transfer Agent Optimization

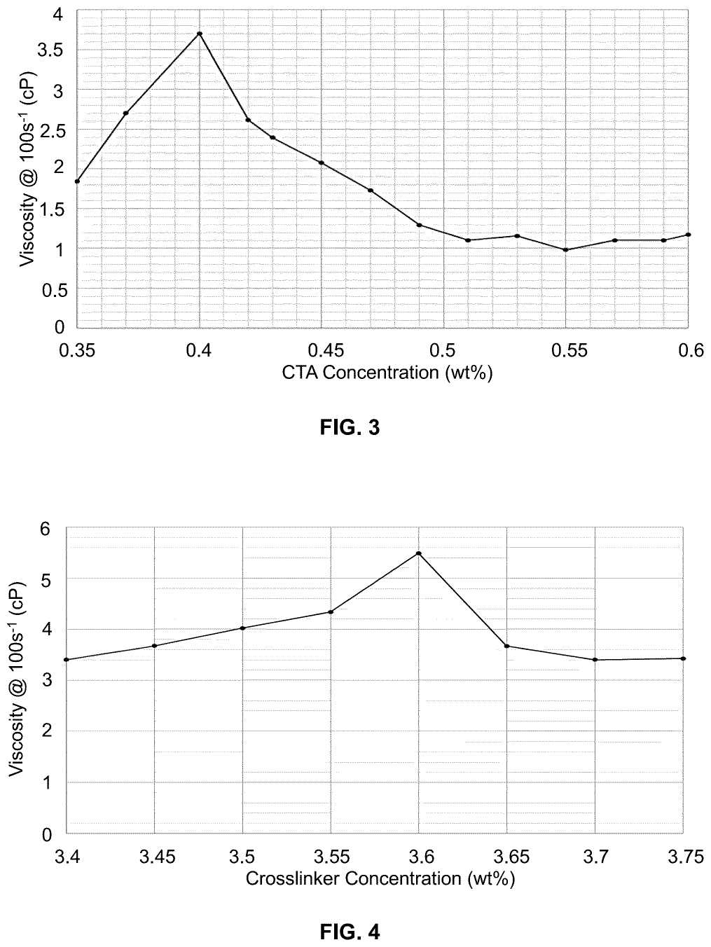

A recipe using 6 wt % acrylamide, 2 wt % TMAC, and 0.1 wt % VAZO 56 was used in this study. The initial CTA concentration for this study was determined from previous studies using similar technology for creating scale inhibitors. Due to the mechanisms required for scale inhibition, smaller polymer molecules are required. These scale inhibitor studies were a good starting point for increasing polymer size by changing the CTA concentration. The CTA concentration was steadily decreased, and the viscosity of each newly synthesized high viscosity friction reducer batch was measured using a Grace 5600 HPHT rheometer. All samples were diluted with deionized water to a total polymer concentration of 1 wt % and mixed until homogeneous. Sample viscosity was measured at various shear rates, but the primary reported viscosity in this study will be at 100 s⁻¹. This particular shear rate is highlighted because it is the most common shear rate encountered in pipe flow during hydraulic fracturing. The viscosity change due to changing CTA concentration is shown in FIG. 3.

High viscosity friction reducer solution viscosity increased with decreasing CTA concentration. However, there was a limit where the high viscosity friction reducer solution viscosity began to decrease as CTA concentration decreased. The peak viscosity occurred when the CTA concentration was 0.4 wt %. Beyond this concentration, the viscosity began to decrease steadily. This is because the high viscosity friction reducer polymers eventually reached a point where they were so large that they no longer dispersed in water. When mixing the high viscosity friction reducer in solution, the fluid system became a gel-in-water mixture rather than a homogeneous solution. This gel is closer to solids suspended in solution and provides no additional viscosity to the fluid, thereby reducing the total viscosity. This phenomenon, where the polymer became too large and would no longer disperse in solution, was observed throughout the high viscosity friction reducer optimization process. This study showed that a recipe containing 6 wt % acrylamide, 2 wt % TMAC, 0.1 wt % VAZO 56, and 0.4 wt % CTA could provide some viscosity to the solution, but it was still low, ˜3.7 cP at 100 s⁻¹. In order to further increase the viscosity and create a self-degrading high viscosity friction reducer, a weak crosslinker was added to the system.

### Crosslinker Optimization

Once the optimum CTA concentration was determined, a recipe of 6 wt % acrylamide, 2 wt % TMAC, 0.1 wt % VAZO 56, and 0.4 wt % CTA was used in this study. Crosslinker concentration was increased steadily, and the viscosity of each newly synthesized high viscosity friction reducer recipe was measured. All samples were diluted with deionized water to a total polymer concentration of 1 wt % and mixed until homogeneous. The viscosity at 100 s⁻¹ with changing crosslinker concentration is shown in FIG. 4.3 below.

FIG. 4 shows that, in general, there is a positive correlation between crosslinker concentration and high viscosity friction reducer solution viscosity. The same limited dispersion effect is seen in this crosslinker study, where the HVFR solution viscosity decreases after reaching a critical concentration. From this study, the optimum crosslinker concentration was determined to be 3.6 wt %. Increasing the crosslinker concentration beyond 3.6 wt % caused the gel particles to be too large to disperse in solution. While this recipe provided suitable initial viscosity, the reaction, and resulting product, were inconsistent.

### Monomer Concentration Optimization

Once the optimum CTA and crosslinker concentrations were identified, the concentration of acrylamide and TMAC were tuned to create a more consistent product. The polymer was at a critical gelation point at 6 wt % acrylamide and 2 wt % TMAC. The final synthesized product would either be a viscous fluid or a flowing gel. Small changes in the reaction procedure would determine the final product state.

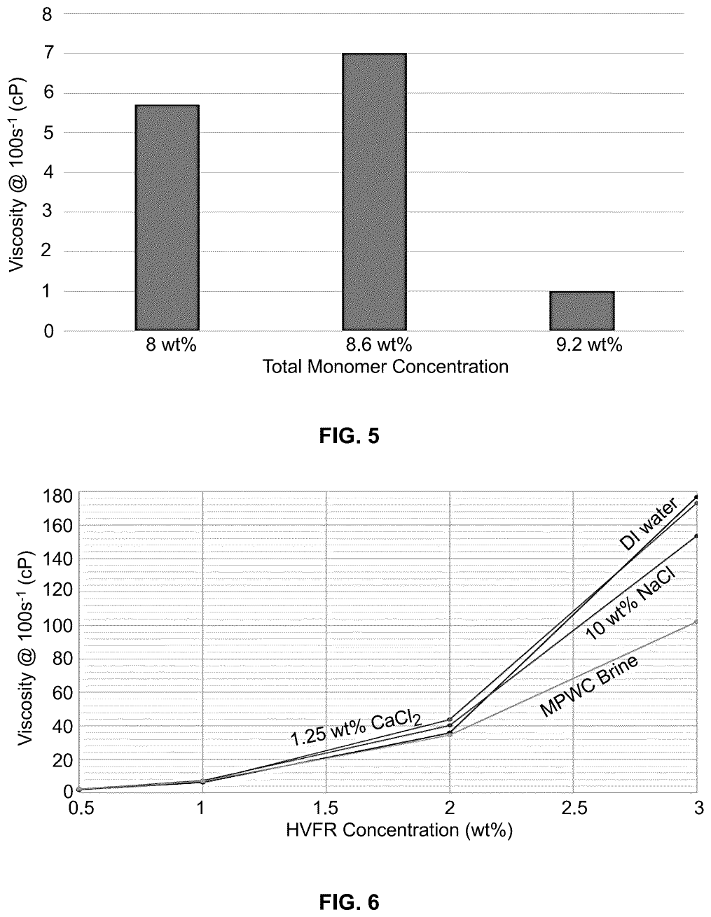

Increasing the monomer concentration of the reaction increases the polymerization rate, which increases the polymer's molecular weight (11). In addition, the increased polymerization rate also increases the yield of the reaction and ensures a more consistent product. However, it is essential to remember that while a high initial molecular weight polymer is desired, the degraded polymer system must still be small enough to ensure good fracture cleanup. Therefore, the monomer concentration should be increased sparingly so that the degraded polymer molecular weight will not be too high. Monomer concentrations were increased steadily until the product was repeatable and consistent. Concentrations of both monomers were increased at the same rate to maintain a molar ratio of 80:20 acrylamide to TMAC. All newly synthesized samples were diluted with deionized water to a total polymer concentration of 1 wt % and mixed until homogeneous. As the bar chart in FIG. 5 shows, once the total monomer concentration exceeded 8.6 wt %, the polymer gel was so strong that it no longer dispersed in the solvent. In addition, the repeatability and consistency of the synthesized product improved when the monomer concentration was raised to 8.6 wt %. Increasing the total monomer concentration by 7.5% could increase the viscosity by 22% while creating a consistent product. This made 8.6 wt % the ideal monomer concentration for the developed product.

Based on the optimization work outlined in this section, the recommended optimized HVFR formula is shown in Table 3. This recipe produces a polymer that provides good viscosity while dispersing quickly in water.

TABLE 3
Optimized HVFR Recipe

| | | Concentration |
|---|---|---|
| Name | Function | (wt %) |
| Acrylamide | Scale Inhibitor | 6.4 |
| Trimethyl Ammonium | Brine | 2.2 |
| Chloride (TMAC) | Compatibility | |
| | Agent | |
| Polyethylene Glycol | Self-degrading | 3.6 |
| Diacrylate (PEGDA-575) | Crosslinker | |
| Thioglycolic acid | Chain Transfer | 0.4 |
| | Agent | |
| 2,2′-Azobis(2- | Initiator | 0.1 |
| methylpropionamidine) | | |
| dihydrochloride (VAZO 56) | | |

Total Polymer Activity: 12.7 wt %

### HVER Characterization

This section describes the studies performed to characterize the rheological properties, degradation rate, fracture cleanup capabilities, and friction reduction performance of the newly developed high viscosity friction reducer polymer. Since this was a proof-of-concept study, the polymer molecular weight distribution and average molecular weight were not quantified. Therefore, all polymer concentrations are described as a weight fraction of total monomer weight (Acrylamide+TMAC). This approach will most likely overestimate the actual polymer concentration, but as a proof-of-concept study, this will be sufficient to identify relative polymer concentration ranges.

### Salinity and Brine Hardness Effects on HVFR Viscosity

The ionic charges that functional groups provide to the polymer backbone are crucial to the viscosity and compatibility that polyacrylamide can provide to a fluid system. However, these charges also make the polymer susceptible to collapse due to changes in salinity and brine composition. To study the effects of salinity and brine hardness on high viscosity friction reducer viscosity, four different solvents were used, deionized water, 10 wt % NaCl in DI, 1.25 wt % CaCl₂) in DI, and MPWC brine. The composition of MPWC brine is given in Table 2. High viscosity friction reducer was diluted in brine at four different concentrations 0.5 wt %, 1 wt %, 2 wt %, and 3 wt %. The viscosity was measured at ambient temperature and pressure. The viscosity as a function of high viscosity friction reducer concentration in the various brines is shown in FIG. 6.

Results from this study show that as high viscosity friction reducer concentration increases, the effects of varying brine salinity and composition become more noticeable. However, the target viscosity for most high viscosity friction reducer applications would require between 1-2 wt % high viscosity friction reducer. Within this concentration range, the brine effects are negligible. This high viscosity friction reducer system is a lot more resilient to brine changes than its anionic counterparts due to the way it maintains its linear form. While anionic polyacrylamides rely on ionic interference to stay linear, cationic polyacrylamides usually rely on large functional groups to maintain their linear form through steric hindrance. TMAC is a large functional group that can provide steric hindrance, thereby reducing the effects of salinity and brine hardness on polymer viscosity.

### Temperature Effects on HVFR Viscosity

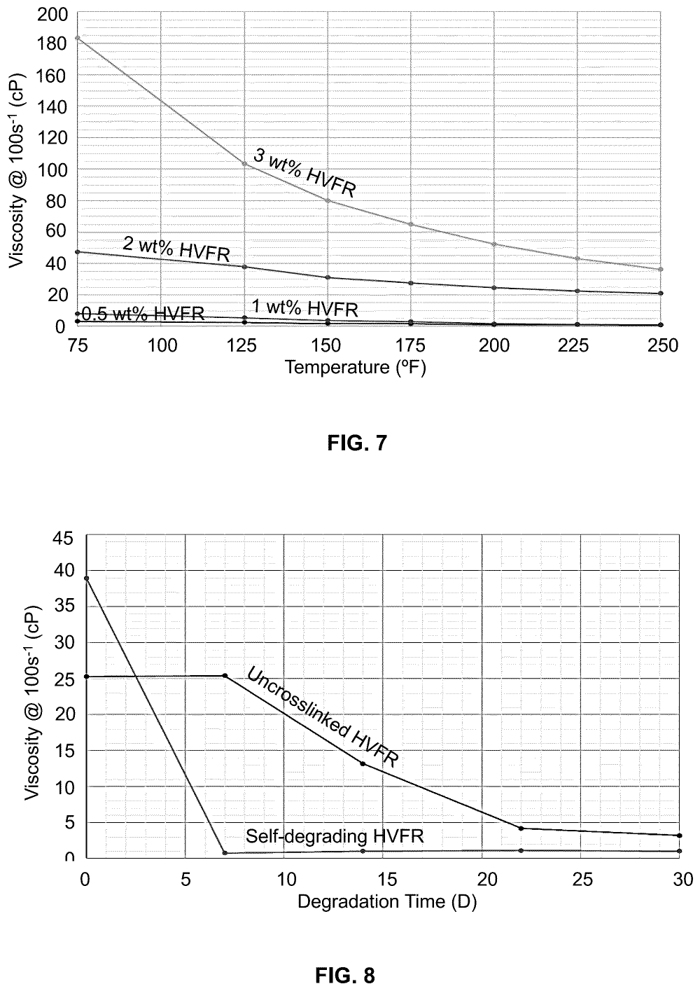

In high viscosity friction reducer applications, the effects of temperature on viscosity can have detrimental effects since the viscosity provided is essential to improving proppant transport. Therefore, if the viscosity of the solution is significantly reduced, the proppant carrying capabilities, and consequently the well productivity, of the system will most likely decrease. Initial temperature effects on high viscosity friction reducers are usually not seen because the high pump rates cause convective heat transfer, rapidly cooling the surrounding reservoir (15, 16). However, as the fracture grows, the interstitial velocity of the fluid in the fracture begins to slow down, reducing the convective heat transfer to the reservoir. The slower interstitial velocity in the fracture results in the fluid temperature at the fracture tip being almost the same as the reservoir temperature. This creates a temperature gradient across the fracture, with the hottest fluid in the fracture tip and the coolest fluid near the wellbore (16, 17). Therefore, when measuring temperature effects on high viscosity friction reducer viscosity, capturing the full range of expected temperatures is essential to appropriately evaluate the expected viscosity profile along the fracture. Currently, the Midland basin has a reservoir temperature ranging from 140° F. in the Upper Spraberry to 200° F. in the Lower Wolfcamp (18). Therefore, this study will evaluate the viscosity between 75° F. and 250° F. to gauge high viscosity friction reducer performance with increasing temperature appropriately. MPWC brine was chosen as the diluting brine to closer replicate field conditions. Temperature effects were measured at four different HVFR concentrations 0.5 wt %, 1 wt %, 2 wt %, and 3 wt %. All samples were measured in a Grace 5600 HPHT rheometer. The sample cup was pressurized to 200 psi to prevent the sample from boiling at high temperatures. The high viscosity friction reducer system's viscosity change as temperature increases is shown in FIG. 7.

As mentioned previously, the recommended HVFR concentration would be 1-2 wt %. From this study, the temperature effects at 1 wt % high viscosity friction reducer are very detrimental, reducing the solution viscosity to ˜1 cP at expected reservoir temperatures. Therefore, it is recommended to increase the high viscosity friction reducer concentration to 2 wt %. The viscosity degradation at 250° F. would be ˜50% at this concentration. Although extreme, the viscosity would remain within the target viscosity for high viscosity friction reducer applications. This study suggests that the high viscosity friction reducer has good thermal stability and can still provide good viscosity with minimal increase in HVFR concentration.

### HVER Degradation Profile

This section outlines the high viscosity friction reducer degradation profile study. This study evaluated the degradation performance of the high viscosity friction reducer without a breaker. Since fracture cleanup depends on the high viscosity friction reducer fluid viscosity, this study will provide a good indicator of the speed and effectiveness of fracture cleanup of this novel self-degrading high viscosity friction reducer. The degradation profile was performed at three different temperatures, 195° F., 160° F., and 130° F. While varied, this range would capture expected reservoir temperatures in the Midland basin. This study was performed at the previously recommended high viscosity friction reducer concentration of 2 wt % and diluted in MPWC brine. In addition, the degradation profile of an uncrosslinked cationic polyacrylamide was measured to compare against the newly developed HVFR system.

The high viscosity friction reducer degradation profile at 195° F. is shown in FIG. 8. The self-degrading high viscosity friction reducer can degrade to 1 cP within 7 days of incubation. In contrast, the uncrosslinked high viscosity friction reducer took 21 days to reach a stable degraded viscosity of ˜3 cP. It should be noted that without a breaker, the tested uncrosslinked high viscosity friction reducer has better degradation than current commercial polymeric high viscosity friction reducers. The tested uncrosslinked high viscosity friction reducer degrades well without a breaker due to the polymerization process. The polymerization process used to synthesize the linear polyacrylamide is similar to what was used by Kot et al. (4). In this polymerization process, the initiator also acts as a crosslinker and can degrade at elevated temperatures. However, due to the strength of the azo bonds, a high temperature is required for polymer degradation. In addition, the uncrosslinked high viscosity friction reducer did not degrade to water-like because the azo bond can only crosslink two polymer chains. This means the polymer chains must still be relatively large to increase the fluid viscosity. Consequently, the degraded polymer chains are still relatively large and will not clean up well from the fracture.

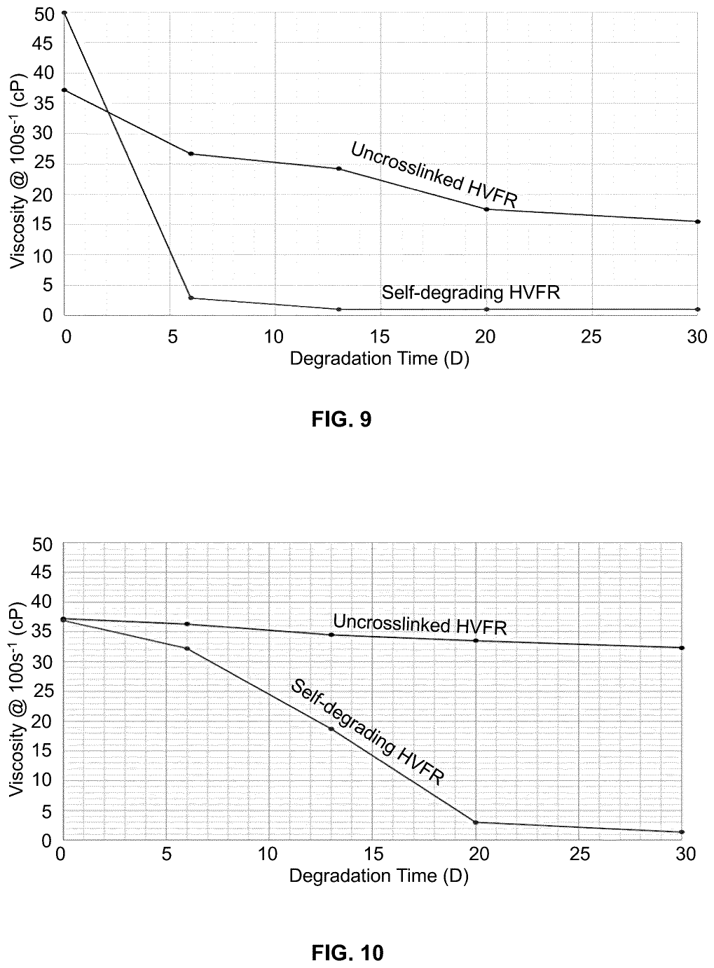

While the high viscosity friction reducer showed good degradation performance at 195° F., this temperature may not be realistic for most reservoirs. The study was repeated at a lower temperature of 160° F. to better simulate average reservoir conditions. The difference in degradation profile becomes a lot more apparent at this temperature. The high viscosity friction reducer decreases to 2.7 cP after 6 days of incubation and degrades to water-like after 13 days. This degradation is much faster than the uncrosslinked high viscosity friction reducer that is still degrading after 30 days of incubation. Given that a typical time frame from initial fracture to production is around two weeks, the self-degrading high viscosity friction reducer would most likely be able to have better fracture cleanup when the well is turned back to production over its uncrosslinked counterpart. The degradation profile of the high viscosity friction reducer systems at 160° F. are found in FIG. 9.

The study was repeated at a lower temperature of 130° F. This temperature is lower than average but would still be the expected reservoir temperature in the upper regions of the Midland basin. At this temperature, virtually no degradation was seen in the uncrosslinked high viscosity friction reducer, while the self-degrading high viscosity friction reducer still showed good viscosity degradation. The viscosity of the self-degrading high viscosity friction reducer solution degraded to ˜3 cP after 20 days and was 1 cP after 30 days of incubation. The degradation profile is shown in FIG. 10.

Although the degradation profile of the self-degrading high viscosity friction reducer is better than that of the uncrosslinked high viscosity friction reducer, it is important to remember that the typical shut-in period between hydraulic fracturing and production averages two weeks. Therefore, at this temperature, the self-degrading high viscosity friction reducer system will most likely not have good fracture cleanup if applied in a reservoir with a temperature of 130° F. or lower. In order to increase the degradation rate of this system, a crosslinker with a weaker bond should be chosen.

### HVER Fracture Cleanup Studies

Viscosity degradation is vital for high viscosity friction reducer cleanup since the mobility of the polymer needs to be favorable for good fracture cleanup. In addition to viscosity degradation, the polymer must still break down to a small enough molecular weight to be easily cleaned from the fracture. Sandpack studies are a more direct way of determining fracture cleanup. Sandpacks of 100-mesh Ottawa sand were used to mimic a propped fracture. The sandpack characteristics, such as porosity and brine permeability, were measured and recorded. The sandpack was then saturated with 2 wt % high viscosity friction reducer in MPWC brine and incubated at 195° F. for one week. The high viscosity friction reducer concentration was chosen based on the results outlined in the viscosity study in the previous section. This study showed that a 2 wt % high viscosity friction reducer system would achieve the target viscosity usually used in field high viscosity friction reducer applications. Based on previous characterization studies, 195° F. was chosen because the high viscosity friction reducer system had the quickest hydrolyzation rate at that temperature. Since this is a proof-of-concept study, the quickest rate was chosen to speed up experimental time. The brine permeability of the sandpack after one week of incubation was measured. The regained fracture permeability is calculated using Eq. 4 above.

Due to the homogeneity of 100-mesh Ottawa sand, the sandpack properties were very consistent. Two sandpack studies were performed for proper fracture cleanup comparisons. The first was a control experiment with uncrosslinked high viscosity friction reducer, and the second was with the new crosslinked HVFR. The properties of both sandpacks are given in Table 4.

TABLE 4
Sandpack properties

| | Uncrosslinked | Self-Degrading |
|---|---|---|
| | HVFR Sandpack | HVFR Sandpack |
| Length (in) | 13.25 | 13.25 |
| Effective Diameter | 0.73 | 0.73 |
| (in) | | |
| Porosity (%) | 31.3 | 31.1 |
| Pore Volume (mL) | 30.6 | 31.5 |
| Brine Permeability | 6.1 | 6.1 |
| (Darcy) | | |

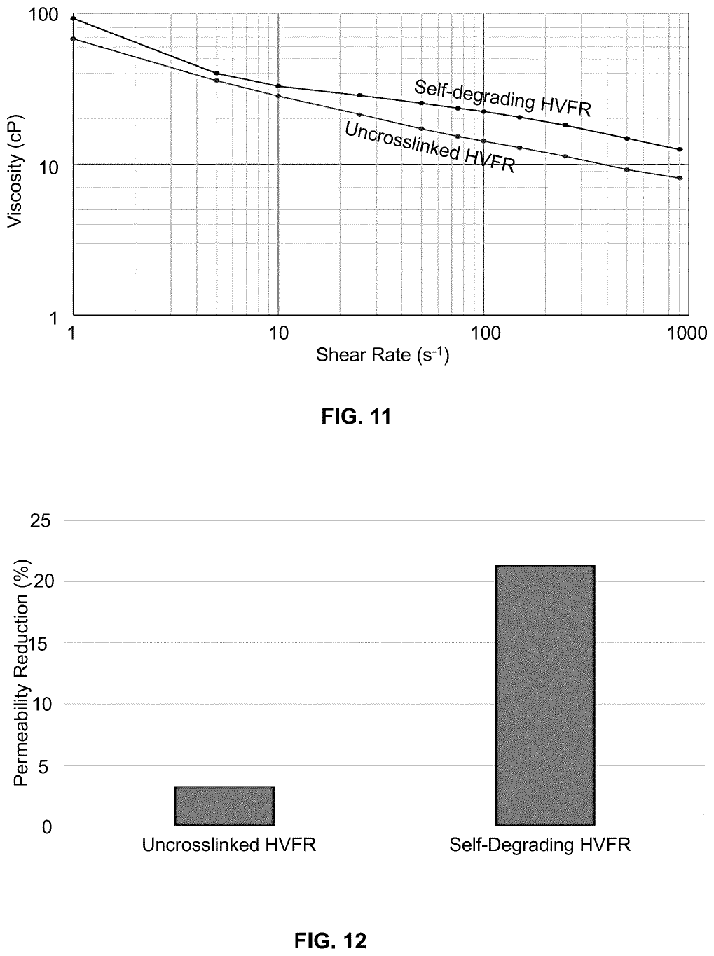

Both sandpack tracer tests showed uniform packing. Porosity and permeability values were within the expected range of a well-prepared 100-mesh Ottawa sandpack. Both sandpacks were injected with 3 PV of 2 wt % high viscosity friction reducer in MPWC. The pressure drop during high viscosity friction reducer injection was measured to observe any plugging that might have occurred during the high viscosity friction reducer saturation process. Viscosity measurements of each sample was taken prior to injection. The measured viscosity was used to calculate the end-point permeability after high viscosity friction reducer saturation. The viscosity of the high viscosity friction reducers used is shown in FIG. 11.

The end-point permeability was used to calculate the percent loss in permeability from the original brine permeability. The self-degrading high viscosity friction reducer showed a 21% permeability reduction at the end of the high viscosity friction reducer injection, significantly higher than the 3% seen in the uncrosslinked high viscosity friction reducer sandpack. Permeability reduction is likely due to larger gel particles plugging the pore throats of the sandpack. This theory is supported by the fact that virtually no plugging was seen in the uncrosslinked high viscosity friction reducer. While the high viscosity friction reducer solutions were mixed until homogeneous, some crosslinked high viscosity friction reducer particles were likely big enough to still plug the sandpack. Unlike sandpack experiments, high viscosity friction reducer will be injected with proppant in the field. Therefore, reduced permeability during pumping will not be an issue. However, if these larger gel particles continue to block the pore throats when the well begins production, this will lead to poor fracture cleanup and reduced fracture permeability. Therefore, the larger high viscosity friction reducer gel particles must break down to be removed easily from the fracture. This polymer breakdown will be evident when the sandpack is tested for regained fracture permeability. The comparison of permeability reduction between the two sandpacks is given in FIG. 12.

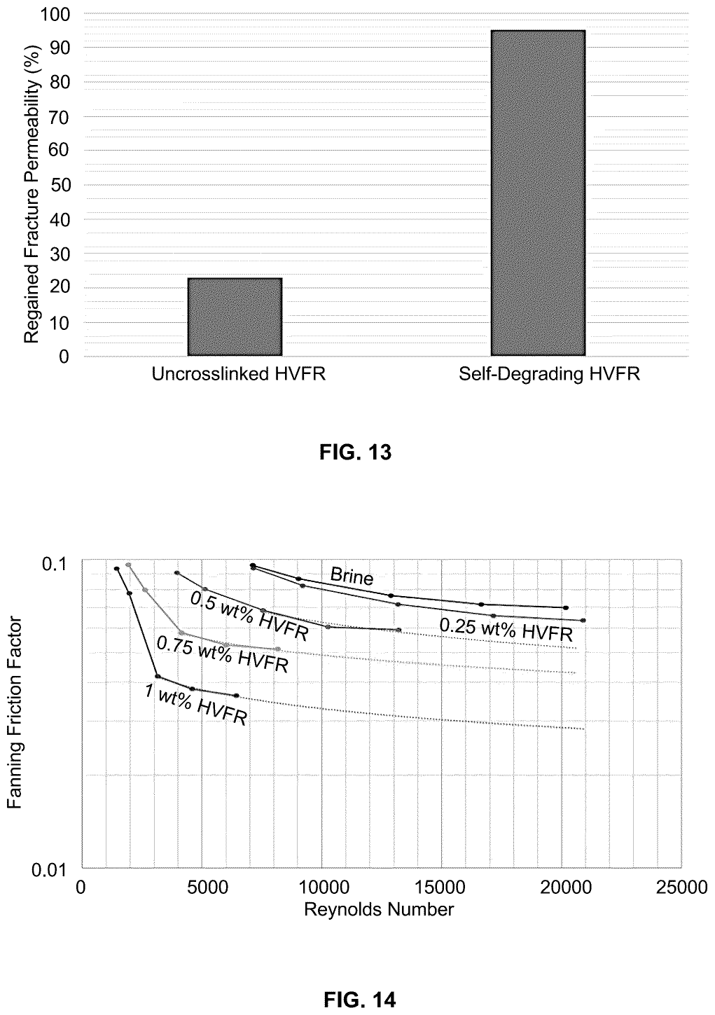

After injection, both sandpacks were incubated at 195° F. for one week. After the one-week incubation, the permeability was measured again by injecting 3 PV of MPWC brine. The flow was reversed to mimic flow back in the fracture when the well is turned to production. The end-point permeability was used to calculate the regained fracture permeability using Eq. 4, where kᵢₙᵢₜᵢₐₗ is the original brine permeability. A comparison of the regained fracture permeabilities between the uncrosslinked and crosslinked high viscosity friction reducer is shown in FIG. 13.

This study showed that the newly developed crosslinked high viscosity friction reducer system had good fracture cleanup with a regained permeability of 95% without the need for a breaker. Despite plugging in the sandpack due to the large high viscosity friction reducer gel particles, these particles seemed to break down enough to be easily flushed out of the sandpack. Regardless, if these particles became an issue for applying this high viscosity friction reducer system, the solution could be filtered prior to injection to mitigate any plugging issues. The crosslinked high viscosity friction reducer showed significant improvements over the traditional uncrosslinked high viscosity friction reducer, with only a 23% regained permeability.

### HVER Drag Reduction Studies

A 10-ft long, 0.5-in diameter flow loop was used to measure drag reduction. Pressure drop along the flow loop was measured using a differential pressure transducer. A test with only MPWC brine was run to establish a baseline Fanning friction factor. All tests were performed at five different flow rates, and the pressure was recorded for 10 minutes. The friction reduction calculations used the average pressure drop across the 10-minute measurement time. Four different concentrations of high viscosity friction reducer were tested, 0.25 wt %, 0.5 wt %, 0.75 wt %, and 1 wt % high viscosity friction reducer in MPWC brine. The high viscosity friction reducer was pre-mixed to create a homogenous solution, then added to the stock tank and circulated at a low rate for 2 minutes to ensure proper mixing. Rheological properties were measured at each concentration with a Grace 5600 HPHT rheometer to quantify the Reynolds number accurately.

The results from the drag reduction studies are given in FIG. 14. As the viscosity of the solution increased from increasing high viscosity friction reducer concentrations, the pump did not have enough strength to achieve the ultra-high Reynolds number of the lower viscosity fluids. Therefore, a power-law regression was performed on the higher-viscosity fluids. The regression was performed only for Fanning friction factors in the turbulent flow regime. The regression line was then extrapolated to compare the Fanning friction factor at higher Reynolds numbers.

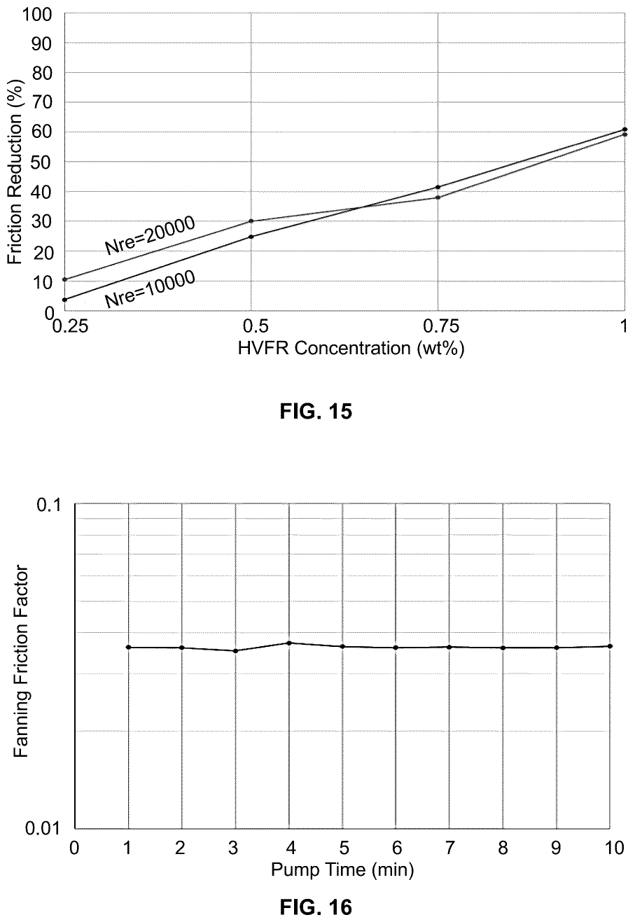

Using the extrapolated regression for the Fanning friction factors and Eq. 9, the percent friction reduction as a function of high viscosity friction reducer concentration was calculated and is shown in FIG. 15. The friction reduction of the high viscosity friction reducer was calculated for two different Reynolds numbers, Nᵣₑ=10,000 and Nᵣₑ=20,000. This was done to determine any differences in friction reduction capabilities at ultra-high Reynold's numbers.

This study showed that the newly developed crosslinked high viscosity friction reducer had good friction reduction capabilities with a friction reduction of 60% at 1 wt % high viscosity friction reducer in MPWC. This study's results also showed no significant difference in friction reduction at ultra-high Reynolds numbers. Finally, analysis of the high viscosity friction reducer performance over time showed no observed performance degradation due to high shear rates. An example of the calculated Fanning friction factor during the 10-minute experiment time is given in FIG. 16. The sample used is the high viscosity friction reducer at 1 wt % in MPWC pumped at 3.3 gpm. This was the highest polymer concentration and pump rate tested, and the high viscosity friction reducer showed no performance degradation. As shown in FIG. 16, the Fanning friction factor remains constant for the duration of the experiment.

### REFERENCES CITED

1. Ba Geri, et al. Static Proppant Settling Velocity Characteristics in High Viscosity Friction Reducers Fluids for Unconfined and Confined Fractures. 53rd U.S. Rock Mechanics/Geomechanics Symposium, New York City, New York, 2019.
2. Elbel, et al. Increased breaker concentration in fracturing fluids results in improved gas well performance. SPE Production Operations Symposium, Oklahoma City, Oklahoma, 7-9 Apr. 1991.
3. Chung, et al. A friction reducer: self-cleaning to enhance conductivity for hydraulic fracturing. SPE Annual Technical Conference and Exhibition, Amsterdam, The Netherlands, 27-29 Oct. 2014.
4. Kot, et al. SPE Journal, 17 (03): 924-930, 2012.
5. Abubakar, et al. Chemical Engineering Research and Design 92 (11): 2153-2181, 2014.
6. Guan, et al. Journal 26 (06): 3848-3854, 2021.
7. Shen, et al. A Cationic Friction Reducer Fully Compatible with Produced Water. SPE/AAPG/SEG Unconventional Resources Technology Conference, Denver, Colorado, 22-24 Jul. 2019.
8. Zhang, et al. Polymer Bulletin 75 (3): 1001-1011, 2018.
9. Tekin, et al. Microporous and Mesoporous Materials 85 (3): 340-350, 2005.
10. Furuncuoglu, et al. Macromolecules 43 (4): 1823-35, 2010.
11. Capek, I. and Akashi, M. Polymer Reviews 33 (4): 369-436, 1993.
12. Paktinat, et al. High Brine Tolerant Polymer Improves the Performance of Slickwater Frac in Shale Reservoirs. North American Unconventional Gas Conference and Exhibition, The Woodlands, Texas, 14-16 Jun. 2011.
13. Nizamidin, et al. Universal Behavior of Polyacrylamide-Based Friction Reducers: Achieving Quantitative Lab Evaluation to Analytical Scale-up Model Development for Field Performance Prediction. Unconventional Resources Technology Conference, Houston, Texas, 26-28 Jul. 2021.
14. Ptasinski, et al. 2001. Flow, Turbulence and Combustion 66:159-182, 2001.
15. Nasr-El-Din, et al. Field Application of HCl-Formic Acid System to Acid Fracture Deep Gas Wells Completed with Super Cr-13 Tubing in Saudi Arabia. SPE International Improved Oil Recovery Conference in Asia Pacific, Kuala Lumpur, Malaysia, 20-21 Oct. 2003.
16. Seth, et al. Numerical model for interpretation of distributed temperature sensor data during hydraulic fracturing. SPE Annual Technical Conference and Exhibition, Florence, Italy, 19-22 Sep. 2010.
17. Sakaida, et al. Estimation of Fracture Properties by Combining DAS and DTS Measurements. SPE International Hydraulic Fracturing Technology Conference & Exhibition, Muscat, Oman, 11-13 Jan. 2022.
18. Forrest, et al. The effect of initial conditions and fluid PVT properties on unconventional oil and gas recoveries in the Wolfcamp formation in the Midland Basin. SPE/AAPG/SEG Unconventional Resources Technology Conference, Houston, Texas, 23-25 Jul. 2018.

What is claimed is:

1. A self-degrading high viscosity friction reducer (HVFR), comprising:
a polymer crosslinked with a crosslinker hydrolyzable at an elevated temperature.

2. The self-degrading high viscosity friction reducer of claim 1, wherein the polymer is a non-functionalized polymer or a functionalized polymer comprising at least one monomeric unit.

3. The self-degrading high viscosity friction reducer of claim 1, wherein hydrolysis of the crosslinker in the polymer at the elevated temperature enables self-degradation of the HVFR in the absence of a breaker.

4. The self-degrading high viscosity friction reducer of claim 3, wherein the polymer is crosslinked with polyethylene glycol diacrylate (PEGDA), polyethylene glycol monomethacrylate (PEGMA) or 3,0-Divinyl-2,4,8,10-tetraoxaspiro[5,5]undecane (DVA).

5. The self-degrading high viscosity friction reducer of claim 1, wherein the HVER viscosifies the fracture fluid in a brine.

6. The self-degrading high viscosity friction reducer of claim 1, wherein the elevated temperature is about 130° F. to about 205° F.

7. A method for a breaker-free fracture cleanup in a well at an elevated temperature, comprising:
injecting an amount of the self-degrading high viscosity friction reducer of claim 1 into the well effective to self-degrade, thereby breaking down a viscosified fracturing fluid and effecting fracture cleanup in the well.

8. The method of claim 7, wherein said high viscosity friction reducer self-degrades over about six days when the elevated temperature is about 195° F. or over about thirteen days when the elevated temperature is about 160° F. or over about thirty days when the elevated temperature is about 130° F.

9. A one-component system for a fracture well clean-up, consisting of:
a high viscosity friction reducer (HVFR) that self-degrades over a period of time at an elevated temperature.

10. The one-component system of claim 9, wherein said HVFR comprises a polymer crosslinked with a crosslinker that hydrolyzes at the elevated temperature.

11. The one-component system of claim 10, wherein the polymer is crosslinked with polyethylene glycol diacrylate (PEGDA), polyethylene glycol monomethacrylate (PEGMA) or 3,0-Divinyl-2,4,8,10-tetraoxaspiro[5,5]undecane (DVA).

12. The one-component system of claim 9, wherein the crosslinker in the polymer degrades at the elevated temperature of about 130° F. to about 195° F. over a period of time of about thirty days to about six days.

13. The one-component system of claim 12, wherein the crosslinker in the polymer degrades at 130° F. over about 30 days, at 160° F. over about 13 days or at 195° F. over about 6 days.

14. The one-component system of claim 8, wherein the HVFR viscosifies the fracture fluid in a brine.

15. The one-component system of claim 9, wherein self-degradation of the HVFR enables a system that self-cleans absent a breaker.

16. A self-cleaning method for a clean-up in a fracturing well, comprising:
breaking down a viscosified fracturing fluid in the fracturing well by self-degrading therein the high viscosity friction reducer (HVFR) of the one-component system of claim 9 at the elevated temperature of about 130° F. to about 195° F. over a period of time of about thirty days to about six days.

17. The self-cleaning method of claim 16, wherein the polymer is a crosslinked polyacrylamide.

18. The self-cleaning method of claim 16, wherein self-cleaning occurs absent a breaker.

19. A high viscosity friction reducer, consisting of:
a crosslinked cationic polyacrylamide polymer that self-degrades at an elevated temperature.

20. The high viscosity friction reducer of claim 19, wherein the cationic polyacrylamide polymer is crosslinked with polyethylene glycol diacrylate (PEGDA).

21. The high viscosity friction reducer of claim 19, wherein the elevated temperature is about 130° F. to about 205° F.
